(19) United States
(12) Patent Application Publication
(10) Pub. No.: US 2025/0059997 A1
(43) Pub. Date: Feb. 20, 2025

(54) LOCKING SYSTEM FOR RELEASABLY CONNECTING TWO COMPONENTS OF A SYSTEM

(71) Applicant: DRESEARCH FAHRZEUGELEKTRONIK GMBH, Berlin (DE)

(72) Inventor: Michael WEBER, Berlin (DE)

(73) Assignee: DRESEARCH FAHRZEUGELEKTRONIK GMBH, Berlin (DE)

(21) Appl. No.: 18/724,080

(22) PCT Filed: Jan. 4, 2023
(86) PCT No.: PCT/EP2023/050102

§ 371 Date: Jun. 25, 2024

(30) Foreign Application Priority Data
Jan. 7, 2022 (DE) 10 2022 100 283.7

(51) Int. Cl. F16B 21/16

(52) U.S. Cl. CPC F16B 21/165; F16B 2200/83

(57) ABSTRACT

A locking system for releasably connecting two components of a system comprising an insertion device (12) with a ball lock pin system (16) and a receptacle device (14) which receives the insertion device (12). The receptacle device (14) is designed to receive the insertion device (12) such that the insertion device (12) is movable into a locked state in the receptacle device (14) by means of the ball lock pin system (16) when introduced into the receptacle device (14). The insertion device (12) is operatively connected to a first component, and the receptacle device (14) is operatively connected to a second component. By means of an electrically operated trigger unit (60), the locked state of the insertion device (12) in the receptacle device (14) can be undone so that the insertion device (12) can be removed from the receptacle device (14).

The invention relates to a locking system for releasably connecting two components of a system.

Connection systems are an important part of many technical systems in order to connect subsystems, which are in each case separate and independent, to one another. Since the type of connection frequently merely plays a minor part, it should be as easy as possible to operate and be realizable without considerable expense.

Simple connection systems have, for example, a method of operation which is intuitive for the user and can be deployed without considerable efforts such that the desired secure connection can be provided accordingly.

A wide variety of plug connection systems, which have the previously desired criteria according to their purely mechanical method of operation, are therefore already known in the prior art.

Purely mechanically provided ball lock pin systems have proven to be practical for specific applications. One example from the prior art is presented in more detail below.

Thus, a ball lock pin is to be inferred as being known from EP 1 707 826 B1. The disclosure shows a ball lock pin for releasable fastening to an object having an opening with an undercut, with a fixing pin having a guide receptacle, which is equipped with a handle and has at least one locking element at its free end opposite the handle, which locking element can be adjusted by a tappet which can be displaced relative to the fixing pin in the guide receptacle against the force of a spring braced against the fixing pin from a latching position blocking the passage of the fixing pin through the opening into a release position which unblocks the passage and extends into a recess of the tappet. The tappet is guided from the guide receptacle through the handle out of the fixing pin, wherein the spring is formed by an elastically deformable web of the handle which is in contact with the end of the tappet projecting from the guide receptacle.

Most purely mechanical connection systems are limited in terms of their area of application to simple ranges of tasks. In this respect, they lack a certain flexibility for interactive deployment with the systems to be connected. With the increasing networking and digitization of objects and work processes, there is currently a growing need for solutions which can be integrated into this development as seamlessly as possible. This applies in equal measure to connection systems.

The object of the invention is to now provide a locking system which at least partially overcomes the disadvantages outlined above.

According to the invention, it is provided that a locking system for releasably connecting two components of a system is provided. Such a locking system comprises an insertion device with a ball lock pin system and a receptacle device which receives the insertion device, wherein the receptacle device is designed to receive the insertion device such that the insertion device is movable into a locked state in the receptacle device by means of the ball lock pin system when introduced into the receptacle device. The insertion device is connected to a first component, and the receptacle device is connected to a second component of the system. By means of an electrically operated trigger unit of the locking system, the locked state of the insertion device in the receptacle device can be undone so that the insertion device can be removed from the receptacle device.

In this way, it is possible to provide a locking system, with which the disadvantages outlined above are at least partially overcome by purely mechanical systems.

This clear structuring of the locking system ensures that a desired locking of the two components to be locked, i.e., the insertion device and the receiving receptacle device, is constantly achieved, even in the case of rapid locking processes. These components are, for example, coupled to respective systems to be connected or even substantially arranged on these, for example at least partially reversibly releasably fastened. A permanent location of these components with suitable fastening means on the respective systems to be connected is also conceivable. The presented locking system has sufficient flexibility for this due to its substantially modular construction.

The force to be applied to undo the locking is applied exclusively by the electrically operated trigger unit. Consequently, it is possible to bring about this process solely by applying a corresponding electrical voltage. The presented locking system is designed such that a corresponding mechanical design of the connection mechanism means that there is no other possibility of releasing the connection. Consequently, the advantage is a very easy-to-operate system which, in addition, due to the electrically operated trigger unit, offers a plurality of coupling possibilities to further functions of the components to be connected. At the same time, the presented locking system is compact and offers the possibilities of allowing a flexible design of the materials to be deployed, depending on the area of application. Advantageously, the particular benefits of the ball lock pin system are utilized in order to convert them to a significantly more complex and surprisingly new system in a way which has never been seen before. In addition, the form of the triggering mechanism in connection with the benefits of the ball lock pin system offers the advantage that a particularly low-wear locking system can be provided. The surprisingly effective connection of the individual components can also be achieved at a reasonable price, so that an inexpensive locking system can consequently also be provided in an advantageous manner. Depending on the nature of the selected materials, it is possible to also provide greater connection forces with the presented system. The individual components can be flexibly dimensioned and the functionality of the electrically operated trigger unit can, additionally, be advantageously adapted in a user-defined manner with the aid of a suitable electronic circuit, for example. However, the basic functionality of the presented locking system provided constantly remains the same, even in the highly diverse variations with regard to dimensioning suitable for the respective intended application.

In a further preferred configuration of the invention, it is provided that a system is provided, which comprises a locking system according to any one of the preceding claims 1 to 12. The advantages mentioned above also apply, insofar as they are transferable, to the presented system.

Further preferred configurations of the invention are set out by the remaining features mentioned in the subclaims.

Thus, it is provided in a further configuration of the invention that the electrically operated trigger unit comprises at least one electromagnetic device, in particular a lifting magnet device.

Consequently, the advantages mentioned above can be achieved particularly easily and effectively. The mentioned components are constantly to be positioned in such a way that the desired functionality in terms of a defined unlocking process can be guaranteed by means of the electrically operated trigger unit. Depending on which holding forces are to be applied, a dimensioning and material selection of the force-absorbing components are to be provided. The lifting magnet which has to apply the force for safe unlocking is also to be dimensioned accordingly. This condition is seamlessly linked to the previous disclosure content and is, consequently, to be deemed a clearly executable teaching.

It is also provided in a further configuration of the invention that the electrically operated trigger unit is designed, following receipt of a trigger signal, to undo the locking after a user-defined adjustable time interval and/or after achieving a user-defined condition.

The trigger signal can be provided, for example, with an operating element configured for these purposes. For example, a simple push-button can be provided, which correspondingly sends a signal to the electronics provided so that the electrically operated trigger unit brings about the desired unlocking process.

The achievement of a user-defined condition can, for example, be in the form of a successfully checked access authorization. It is also conceivable that the user-defined condition is the result of a positive clearance process, for instance of a data carrier.

Instead of a push-button, any further suitable alternatives for technically realizing the claimed teaching are also conceivable.

In this context, the trigger signal is, for example, the result of a previous unlocking process. Initially, there is at least one unlocking request. The unlocking requirements are then checked.

Depending on the result of this check, a trigger signal which ultimately leads to a successful unlocking process or not is then effected. An unlocking request can be effected manually or automatically. A manual unlocking request can be effected, for instance, by means of a feeler, a switch, a mechanical or an electronic key or the like. An automatic unlocking request can be triggered, for instance, in particular by an external process.

In this context, the check of the unlocking requirements can, for instance, depend on the respective application. This can be designed, for instance, so that a check is effected with respect to an authorization of a requesting person who is, for instance, using an electronic key. It is also conceivable that a check is carried out as to whether the system in which the presented locking system is installed is in the state required for the unlocking. A system state of a system can thus be present, for instance, when all of the write processes on a data carrier have been completed.

It is furthermore provided in a further configuration of the invention that the electrically operated trigger unit is designed, following receipt of a trigger signal and as a function of a status of a user-defined adjustable condition detected by a native or system-external unlocking device, to undo the locking.

Such a detected status is provided, for example, so that a general activation of the electrically operated trigger unit can be brought about according to the position of a superordinate switch. In other words, it can consequently be determined whether an unlocking is possible at all or not.

The user-defined condition can be provided, for example, in connection with a safety check of the electrically operated trigger unit, which is to be carried out beforehand.

In addition, it is provided in a further configuration of the invention that the ball lock pin system comprises two spring elements and a ball receiving element positioned between these spring elements having at least one ball element and having respective spring receiving regions which are arranged together in a guide cylinder element of the ball lock pin system with at least one ball opening region, so that the ball receiving element is movable to a starting position for an unlocked state of the insertion device by means of the two spring elements and without further external force influences and/or force influences caused by the trigger unit.

The advantage is that the two separate spring elements are configured such that a defined starting position can, consequently, constantly be brought about if this is desired. For this purpose, the components of the system which are to be locked to one another are simply to be kept only in a neutral state. Consequently, uncomplicated readiness and easy-to-use functionality can constantly be guaranteed. The ball element can, for example, be spherical, but can also be configured in a roller shape. It is also conceivable that the spherical element itself is a ball or a roller. The ball element with its respective characteristics can also be referred to generally as a latching element. That is to say that, in this context and in other words, latching elements are provided that withstand the shearing forces which occur during an attempt to remove them and thus prevent the removal or unlocking. The ball element or latching element must be rotationally symmetrical in at least one dimension so that they can roll on the boundary surfaces. To this end, it is consequently advantageous if the ball element is spherical or even roller shaped. The geometries of the elements interacting with the latching elements must be designed depending on the geometries of the latching elements.

It is also provided in a further configuration of the invention that the ball receiving element and the spring receiving regions are provided together as one piece. The fact that the ball receiving element and the spring receiving regions together form a one-piece unit results in a simple and, consequently, inexpensive variant of the presented locking system. In this way, a particular stability in this region, which is important for the locking process, is also promoted. In this way, it can be particularly effectively ensured that these two components are connected to form a substantially rigid unit.

Moreover, it is provided in a further configuration of the invention that the ball receiving element and the respective spring receiving regions are provided as exchangeable and modularly assemblable components of the insertion device.

In this way, a particularly flexible locking system can be provided, which is to be designed to be quickly and inexpensively adaptable, for example, to respective ranges of tasks. Consequently, it is for example conceivable that a respective ball receiving element can be selected depending on the size of the necessary ball elements which are to be mounted there. Compatibility with the modular spring receiving regions is constantly a requirement which must be met. However, corresponding inserts for the spring receiving regions are also optionally conceivable here, so that the modular principle can be extended at will at this point.

It is also provided in a further configuration of the invention that the ball lock pin system comprises a cap element which is designed to receive a first spring element and a first spring receiving region of a ball receiving element, so that when the insertion device is received in the receptacle device, a defined displacement process of the ball receiving element can be brought about for locking purposes due to a contact between the cap element and an inner wall region of the receptacle device.

This cap element is consequently substantially provided in the foremost position in the plug-in direction of the insertion device. Consequently, contact with a front region of this cap element prompts said element to deflect for a certain length due to the provided spring element, wherein the dimensioning of the first spring element in combination with the first spring receiving region correspondingly predefines the limits of such a movement sequence. In this way, a targeted locking can then be conveniently brought about, wherein the manner of functioning of the existing ball lock pin system results in the previously mentioned advantages in this context.

Due to this inventive amalgamation of intrinsically separate ranges of tasks, the result is consequently a compact locking system which can be produced at a reasonable price and which, moreover, has the aforementioned method of operation for the unlocking process.

Furthermore, it is provided in a further configuration of the invention that the cap element is arranged in a reversibly movable manner in a guide cylinder element of the ball lock pin system in a through-opening of the guide cylinder element, so that the cap element is movable from a positioning projecting beyond the outer dimensions of the guide cylinder element into a positioning at least partially merging with the guide cylinder element. The previously mentioned advantages are, consequently, even more achievable.

In addition, it is provided in a further configuration of the invention that the guide cylinder element is substantially arranged between the cap element and electrically operated trigger unit, so that displacement processes of the ball receiving element movably mounted in the guide cylinder element can either be carried out due to an action of the cap element on the ball receiving element or due to an action of the electrically operated trigger unit on the ball receiving element.

It is also provided in a further configuration of the invention that an unlocking process can only be carried out by means of the electrically operated trigger unit after a previously detected authorization check having a user-defined result.

For example, it is conceivable that a profile of the user, i.e., the fingerprint, can be provided as a necessary condition by means of a fingerprint scanning device in order to then bring about the desired locking process after a successful scan. Entering a code, a voice-controlled function or a facial scan are also conceivable. A specific sequence of pressure pulses, for example short, short, long or the like, can also be previously set in a user-defined manner, so that the result is a locking system which is as easy to operate as possible.

Finally, it is provided in a further configuration of the invention that the receptacle device and the electrically operated trigger unit are each designed so that the electrically operated trigger unit, during an insertion process of the insertion device into the receiving receptacle device, can substantially also be lowered in the receptacle device, or wherein, during an insertion process of the insertion device into the receiving receptacle device, the electrically operated trigger unit is guidably mounted in the receptacle device.

The electrically operated trigger unit can, consequently, be constantly positioned in a surprisingly simple manner so that a reliable method of operation of the presented locking system is constantly guaranteed. Consequently, the electrically operated trigger unit can also be easily protected against external influences, for instance an unauthorized actuation, in a surprisingly simple manner so that a reliable method of operation of the presented locking system is likewise constantly guaranteed.

The presented locking system is suitable for any components which are substantially separate and which need to be locked to one another in a suitable manner, to be reversibly connected to one another. In the case of this connection, which can also be referred to as locking, a user-friendly unlocking process with an inexpensive and reliable functionality can be provided in a surprisingly simple manner. In this way, the highly diverse components of an information technology architecture can, for example, be reversibly locked or connected to one another.

The invention is explained in greater detail below on the basis of an exemplary embodiment and associated drawings, wherein:

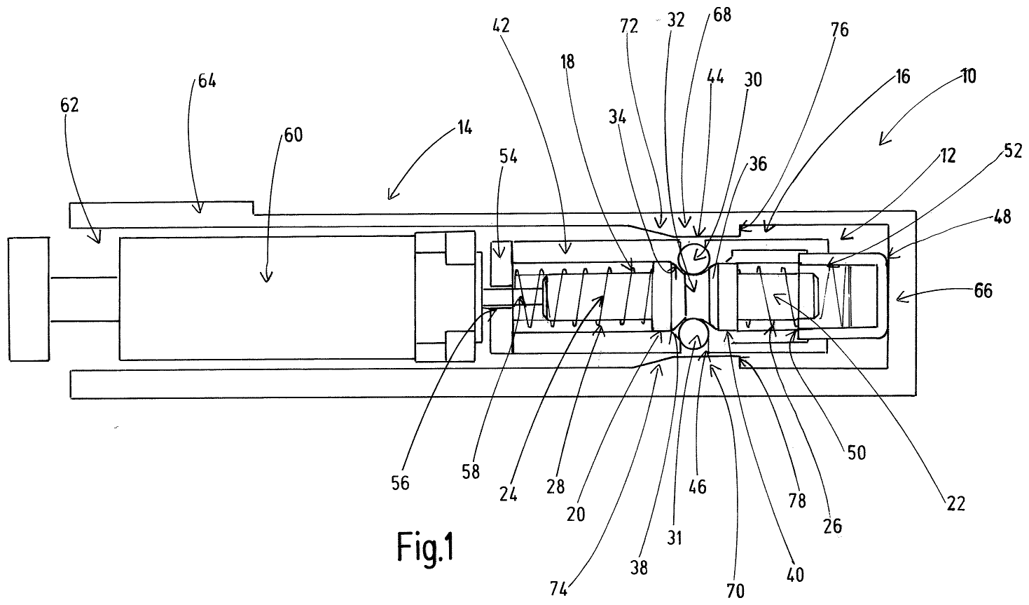

FIG. 1 shows a schematic sectional representation of a locking system in a non-locked state;

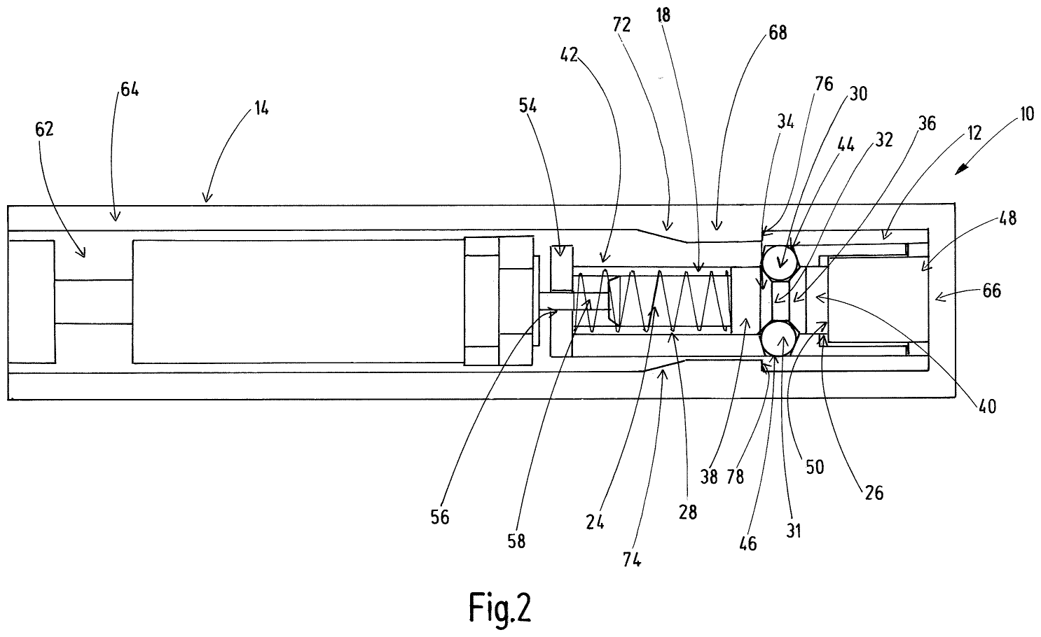

FIG. 2 shows a further schematic sectional representation of the locking system from FIG. 1 shortly before a locked state;

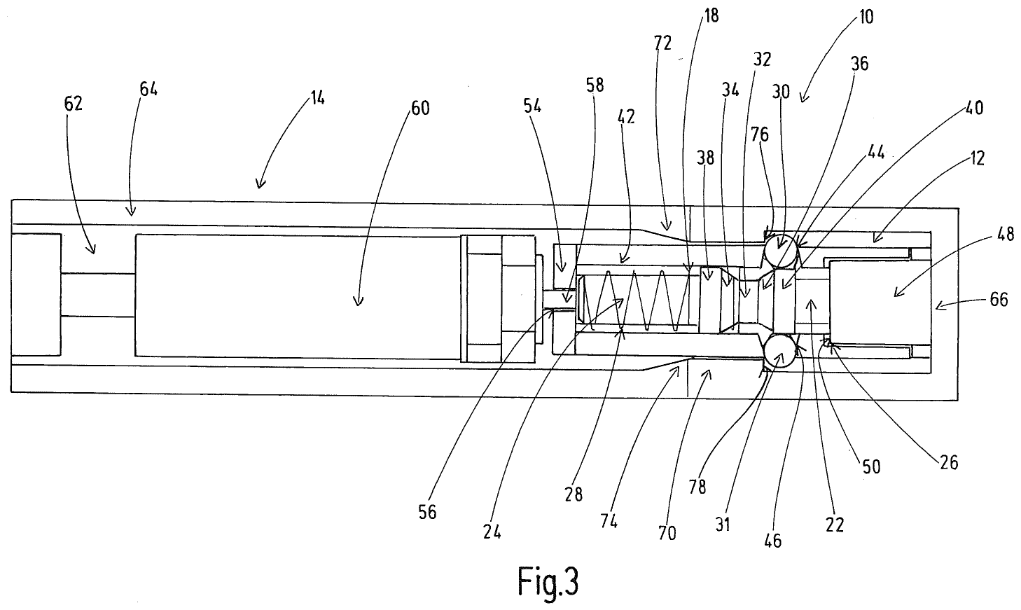

FIG. 3 shows a further schematic sectional representation of the locking system from FIG. 1 in a locked state;

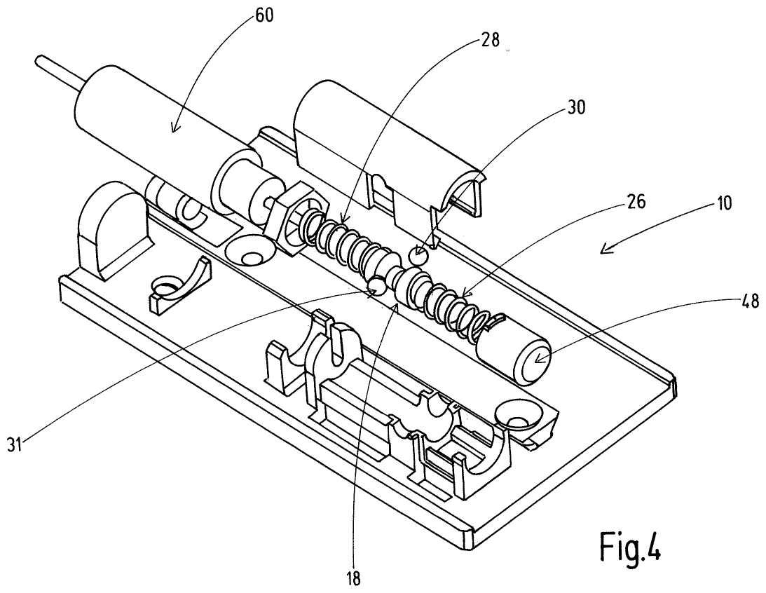

FIG. 4 shows a perspective detailed representation of a further locking system;

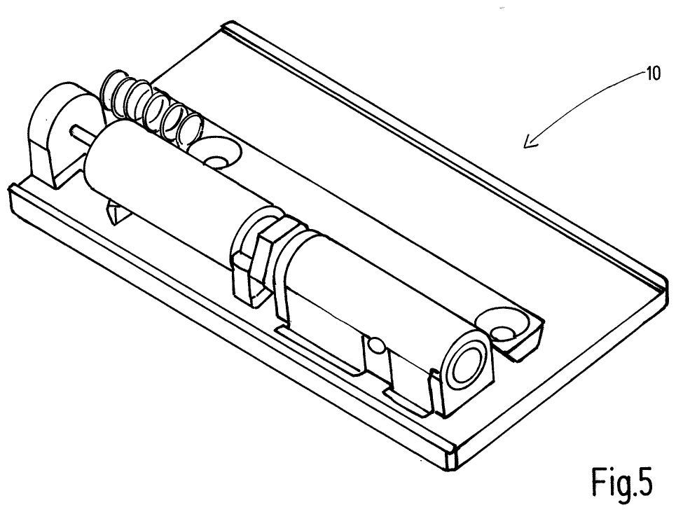

FIG. 5 shows a further perspective detailed representation of the locking system from FIG. 4;

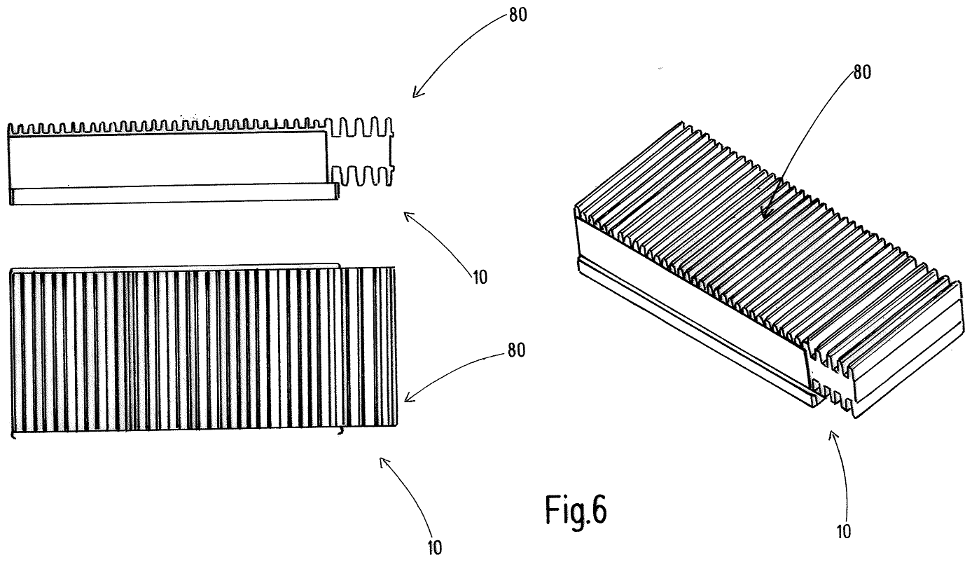

FIG. 6 shows various schematic representations of an SSD rack mount system with a locking system;

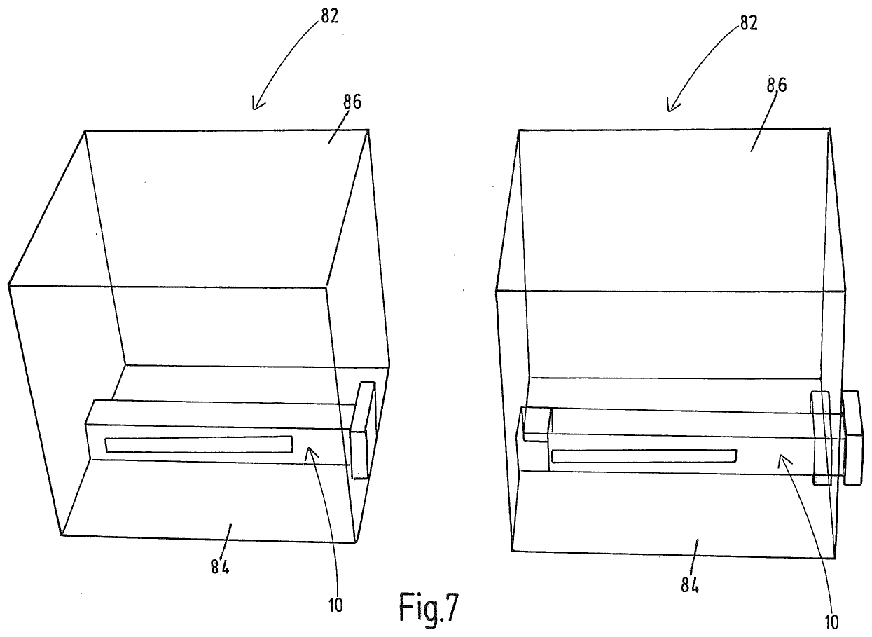

FIG. 7 shows various schematic representations of a system with a locking system.

FIG. 1 shows a schematic sectional representation of a locking system 10 in a non-locked state. This locking system 10 is depicted with an insertion device 12 and a receptacle device 14 which receives the insertion device 12. The insertion device 12 is operatively connected to a first component, and the receptacle device 14 is operatively connected to a second component, which can be releasably connected to one another to form a system. Specific embodiments are addressed in FIGS. 6 and 7. The insertion device 12 is depicted with a ball lock pin system 16.

The ball lock pin system 16 is depicted with a latching slide element 18 which comprises a ball receiving element 20 and respective spring receiving regions 22, 24.

The first spring receiving region 22 is depicted—on the right—in relation to the image plane and has received a first spring element 26 in this representation, which is in a relaxed state. The second spring receiving region 24 is depicted—on the left—in relation to the image plane and has received a second spring element 28 in this representation, which is likewise in a relaxed state.

Two ball elements 30, 31 are depicted in the ball receiving element 20. It is, for example, conceivable in an embodiment which is not depicted in greater detail that at least two such substantially identical ball elements 30 are provided.

The ball receiving element 20 has an indentation region 32 substantially centrally, which is bordered by respective ramp regions 34, 36. The respective ramp regions 34, 36 are in each case directly attached in one piece to the indentation region 32.

In the depicted embodiment, the latching slide element 18 is provided as one piece. However, in an embodiment which is not depicted in greater detail, it is conceivable that this latching slide element 18 has a multiple-part construction and is provided in a modular manner according to a modular principle.

The latching slide element 18 is provided with its respective components along its longitudinal axis as a rotationally symmetrical body. This is likewise the notion in the case of the modular design which is not depicted in greater detail. In other words, the ball receiving element 20 is, consequently, substantially provided as a cylindrical body with its corresponding regions which vary in terms of their respective diameter.

The respective spring receiving regions 22, 24 have the same diameter as the indentation region 32. However, in an embodiment which is not shown in greater detail, this is not absolutely essential. The spring receiving regions only have to leave enough space for the spring elements. The indentation region depends on a respective ball element diameter, wherein the indentation region must make it possible for the ball element to merge completely with the guide cylinder.

However, in an embodiment which is not depicted in greater detail, it is conceivable that these diameters are in each case provided individually and differently. It is, in addition, conceivable that, in an embodiment which is not depicted in greater detail, the spring receiving regions 22, 24 and the indentation region 32 are provided together as a solid, substantially cylindrical body which is then supplemented in a modular manner by means of fitted-on elements (ramp regions/end regions) to form the final latching slide element 18.

The first ramp region 34 is depicted on the left of the indentation region 32 in relation to the image plane and the second ramp region 36 is depicted on the right of the indentation region 32 in relation to the image plane. Respective end elements 38, 40 adjoin the ramp regions 34, 36 in each case from the outside. The first and second end elements 38, 40 each have the same diameter which is dimensioned so that the latching slide element 18 is mounted in a guide cylinder element 42 of the ball lock pin system 16 so that it can be guided in a substantially appropriate and substantially low-friction manner.

The guide cylinder element 42 has respective ball opening regions 44, 46. The first ball opening region 44 is depicted at the top in relation to the image plane. The second ball opening region 46 is depicted at the bottom in relation to the image plane. However, in an embodiment which is not depicted in greater detail, it is conceivable that at least two such opening regions are provided, wherein the number depends on the number of ball elements provided.

The depicted ball opening regions 44, 46 are designed to allow the ball elements 30, 31 to exit at least partially upwards and downwards or outside of the guide cylinder element 42.

A cap element 48 is depicted on the right in relation to the image plane as part of the insertion device 12. The cap element 48 is designed to receive the first spring receiving region 22 and the first spring element 26. To this end, it has a round opening region 50 which, in this representation, has a diameter which substantially corresponds to that of the first spring element 26 so that it is not only at least partially received in it, but rather it is also guidably mounted by it.

The cap element 48 is depicted at least partially received in a guidably mounted manner in a through-opening 52 of the guide cylinder element 42. In other words, this through-opening 52 is designed to receive the cap element 48 such that it is movable to the left and right in relation to the image plane through this through-opening 52.

The second spring element 28 is depicted held by a stopping element 54 on the left in relation to the image plane. In other words, this second spring element 28 is depicted held in its rest position between the stopping element 54 and the ball receiving element 20. The stopping element 54 is depicted substantially seamlessly arranged on the guide cylinder element 42 and has a guide through-opening 56 substantially centrally. A tappet element 58 of an electrically operated trigger unit 60 protrudes through this guide through-opening 56.

In this non-locked state, which can also be referred to as the starting position, the latching slide element 18 is in a position in which the ball elements 30, 31 are located in the region of the latching slide element 18 having the smallest outer diameter, as a result of which they can merge fully with the guide cylinder element 42. In other words, the ball elements 30, 31 are depicted mounted in the indentation region 32. To this end, in precisely this position of the latching slide element 18, the two spring elements 26, 28 have to either be in force equilibrium, or the latching slide element 18 has to be pressed by the second spring element 28 against a suitably positioned stop. In this representation, the fixing components of the receptacle device 14 are not yet in a positioning which can be achieved for the locking process. No further forces act on the cap element 48 yet.

The depicted receptacle device 14 is designed to receive the insertion device 12 and the electrically operated trigger unit 60 in an inner region 62. In other words, the receptacle device 14 has a substantially cylindrical hollow body 64 which is designed to receive the insertion device 12 and the electrically operated trigger unit 60 in its inner region 62. This cylindrical hollow body 64 is delimited to the right in relation to the image plane by a terminating element 66, with which the cap element 48 lies in contact in this representation.

The cylindrical hollow body 64 has two guide rail elements 68, 70 on its inner walls. These guide rail elements 68, 70 have respective conducting regions 72, 74. That is to say that the guide rail elements 68, 70 are delimited on the left in relation to the image plane by these conducting regions 72, 74 which start at a diameter of the cylindrical hollow body 64 and go into the inner region 62 up to a maximum extent of the respective guide rail elements 68, 70. By contrast, these respective guide rail elements 68, 70 are in each case delimited on the right by step elements 76, 78.

The maximum extensions of the respective guide rail elements 68, 70 into the inner region 62 together have the effect that the guide cylinder element 42 can be further moved into the receptacle device 14 in a defined manner by these guide rail elements 68, 70, which can also be provided, for example, at least partially circumferentially in the inner region 62 as an at least partially one-piece region. In this respect, these guide rail elements 68, 70 have the effect that the guide cylinder element 42 is first slid with the aid of the respective conducting regions 72, 74 and can then be moved further inside the receptacle device 14 in a defined position by the maximum extents. The ball elements 30, 31 are prevented from moving outwards through the ball opening regions 44, 46, since they are prevented from doing so by the guide rail elements 68, 70 or by respective regions of these which project into the inner region to the maximum.

In other words, when the receptacle device 14 is fitted onto the insertion device 12 from the right (in relation to the image plane), the ball elements 30, 31 are initially blocked from the outside by the region having the small inner diameter of the receptacle device 14.

The presented arrangement (inner region of the receptacle device 14, outer region of the insertion device 12) is preferably rotationally symmetrical. Consequently, the conducting regions 72, 74, the guide rail elements 68, 70, the step elements 76, 78 as well as the ramp regions 34, 36 and the indentation region 32 are preferably correspondingly circumferential regions.

FIG. 2 shows a further schematic sectional representation of the locking system 10 from FIG. 1 shortly before a locked state. The reference numerals introduced in FIG. 1 apply so they are not introduced again at this point.

During a further movement of the receptacle device 14 to the left, the cap element 48 is also moved to the left. The latching slide element 18 cannot initially move relative to the guide cylinder element 42 until the ball elements 30, 31 reach the region of the receptacle device 14 having the largest inner diameter.

FIG. 3 shows a further schematic sectional representation of the locking system 10 from FIG. 1 in a locked state. The reference numerals introduced in FIG. 1 apply so they are not introduced again at this point.

The latching slide element 18 can now move to the left due to the force of the considerably compressed first spring element 26, which can also be referred to as a locking spring element, by overcoming the smaller force of the second spring element 28 which acts in the opposite direction and which can also be referred to as the unlocking spring element. The ball elements 30, 31 are pressed outwards so that they project from the guide cylinder element 42 and in this position are blocked by the latching slide element 18 in the position depicted in FIG. 3 by means of the step elements 76, 78, as a result of which the receptacle device 14 is simultaneously permanently blocked.

In the embodiments shown, this electrically operated trigger unit 60 comprises a lifting magnet device. The tappet element 58 is part of the electrically operated trigger unit 60. That is to say that the lifting magnet device is actuated for unlocking, as a result of which the tappet element 58 of the electrically operated trigger unit 60 or the lifting magnet device acts to the right on the latching slide element 18 with a suitably dimensioned force. As long as the sum of the compression force of the lifting magnet device acting to the right and the force of the second spring element 28 directed in the same direction exceeds the current force of the first spring element 26 directed to the left, the latching slide element 18 moves to the right, wherein, in the end position of the latching slide element 18, the ball elements 30, 31 can merge again with the guide cylinder element 42 and the fixation of the receptacle device 14 is undone. As a consequence, the tensioned first spring element 26 pushes the receptacle device 14 to the right via the cap element 48, which completes the unlocking process, and the receptacle device 14 can be extracted to the right from the insertion device 12.

The functionality of the described arrangement requires suitable dimensions. This relates, for instance, to the path which the receptacle device 14 travels from the first contact with the cap element 48 up to the completed fixation. This also relates, for instance, to the path which the latching slide element 18 has to cover between the unlocking and the locking position. This also relates, for instance, to the lengths, the spring constants as well as, possibly, the preloading of the two spring elements 26, 28. This also relates, for instance, to the compression force, the stroke and the holding time of the lifting magnet of the lifting magnet device.

The settings and the possible effects can be brought about easily by a person skilled in the art according to the contents disclosed so far by means of suitable attempts and the disclosed technical instructions, so that detailed embodiments are dispensed with at this point. The spring elements 26, 28 can, for example, have the same dimensions and each have an initial length of 14 mm, wherein the respective spring rate R is 0.926 N/mm in each case.

FIG. 4 shows a perspective detailed representation of a further locking system 10. This is a perspective detailed representation of the locking system 10 depicted in FIGS. 1 to 3. The reference numerals introduced in FIG. 1 apply so they are not introduced again at this point.

FIG. 5 shows a further perspective detailed representation of the locking system 10 from FIG. 4. The reference numerals introduced in FIG. 1 apply so they are not introduced again at this point.

FIG. 6 shows various schematic representations of an SSD (solid state drive) rack mount system 80 having a locking system 10. A hard drive component 81 is equipped with the receptacle device 14. A superordinate housing 83 is equipped with the insertion device 12 as the second component.

FIG. 7 shows various schematic representations of a general system 82 having a locking system 10. It is consequently conceivable that the presented locking system 10 is provided integrated in a superordinate system 82, wherein a locked state is depicted on the left and an unlocked state is depicted on the right in relation to the image plane. Depending on the application, different degrees of integration are conceivable and the possibilities are not significantly limited at this point. A first component 84 can be releasably connected to a second component 86 of the system 16 via the locking system 10. The components 84 and 86 can be any parts, assemblies or the like which are to be connected to one another.

### REFERENCE NUMERALS

10 Locking system

12 Insertion device

14 Receptacle device

16 Ball lock pin system

18 Latching slide element

20 Ball receiving element

22 First spring receiving region

24 Second spring receiving region

26 First spring element

28 Second spring element

30 First ball element

31 Second ball element

32 Indentation region

34 First ramp region

36 Second ramp region

38 First end element

40 Second end element

42 Guide cylinder element

44 First ball opening region

46 Second ball opening region

48 Cap element

50 Round opening region

52 Through-opening

54 Stopping element

56 Guide through-opening

58 Tappet element

60 Trigger unit

62 Inner region

64 Hollow body

66 Terminating element

68 First guide rail element

70 Second guide rail element

72 First conducting region

74 Second conducting region

76 First step element

78 Second step element

80 SSD rack mount system

82 System

84 First component

86 Second component

1. A locking system for releasably connecting two components of a system, comprising an insertion device with a ball lock pin system and a receptacle device which receives the insertion device, wherein the receptacle device is designed to receive the insertion device such that the insertion device is movable into a locked state in the receptacle device by means of the ball lock pin system when introduced into the receptacle device, wherein:
the insertion device is operatively connected to a first component, and the receptacle device is operatively connected to a second component of the system, by means of an electrically operated trigger unit of the locking system, the locked state of the insertion device in the receptacle device can be undone so that the insertion device can be removed from the receptacle device.

2. The locking system according to claim 1, wherein the electrically operated trigger unit comprises at least one electromagnetic device.

3. The locking system according to claim 1, wherein the electrically operated trigger unit is designed, following receipt of a trigger signal to undo the locking after a user-defined adjustable time interval and/or after achieving a user-defined condition.

4. The locking system according to claim 1, wherein the electrically operated trigger unit is designed, following receipt of a trigger signal and as a function of a status of a user-defined adjustable condition detected by a native or system-external unlocking device, to undo the locking.

5. The locking system according to claim 1, wherein the ball lock pin system comprises two spring elements and a ball receiving element positioned between these spring elements having at least one ball element and having respective spring receiving regions which are arranged together in a guide cylinder element of the ball lock pin system with at least one ball opening region, so that the ball receiving element is movable to a starting position for an unlocked state of the insertion device by means of the two spring elements and without further external force influences and/or force influences caused by the trigger unit .

6. The locking system according to claim 5, wherein the ball receiving element and the spring receiving regions are provided together as one piece.

7. The locking system according to claim 5, wherein the ball receiving element and the respective spring receiving regions are provided as exchangeable modularly assemblable components of the insertion device.

8. The locking system according to claim 1, wherein the ball lock pin system comprises a cap element which is designed to receive a first spring element and a first spring receiving region of a ball receiving element, so that when the insertion device is received in the receptacle device, a defined displacement process of the ball receiving element can be brought about for locking purposes due to a contact between the cap element and an inner wall region of the receptacle device.

9. The locking system according to claim 8, wherein the cap element is arranged in a reversibly movable manner in a guide cylinder element of the ball lock pin system in a through-opening of the guide cylinder element, so that the cap element is movable from a positioning projecting beyond the outer dimensions of the guide cylinder element into a positioning at least partially merging with the guide cylinder element .

10. The locking system according to claim 9, wherein the guide cylinder element is substantially arranged between the cap element and electrically operated trigger unit, so that displacement processes of the ball receiving element movably mounted in the guide cylinder element can either be carried out due to an action of the cap element on the ball receiving element or due to an action of the electrically operated trigger unit on the ball receiving element.

11. The locking system according to claim 1, wherein an unlocking process can only be carried out by means of the electrically operated trigger unit after a previously detected authorization check having a user-defined result.

12. The locking system according to claim 1, wherein the receptacle device and the electrically operated trigger unit are each designed so that the electrically operated trigger unit, during an insertion process of the insertion device into the receiving receptacle device, can substantially also be lowered in the receptacle device or wherein, during an insertion process of the insertion device into the receiving receptacle device, the electrically operated trigger unit is guidably mounted in the receptacle device.

13. A system comprising a locking system according to claim 1.

14. The locking system of claim 2 wherein the electromagnetic device is a lifting magnet device.

15. The locking system of claim 3 wherein the trigger signal is from a native or system-external unlocking device.
